(19) United States
(12) Patent Application Publication
(10) Pub. No.: US 2010/0257057 A1
(43) Pub. Date: Oct. 7, 2010

(54) DYNAMIC MODELING ENGINE MATCHING CLIENT CONTROLS WITH ADVERTISER NEEDS

(75) Inventors: Steven E. SMITH, Naperville, IL (US); Brian D. Blecke, Naperville, IL (US)

Correspondence Address: MCGUIREWOODS, LLP, 1750 TYSONS BLVD, SUITE 1800, MCLEAN, VA, 22102, US

(73) Assignee: InADition, LLC, Naperville, IL (US)

(21) Appl. No.: 12/753,556

(22) Filed: Apr. 2, 2010

Related U.S. Application Data
(60) Provisional application No. 61/166,561, filed on Apr. 3, 2009.

(51) Int. Cl. G06Q 30/00; G06Q 10/00; G06F 15/16; G06Q 50/00

(52) U.S. Cl. 705/14.52; 705/14.49; 705/14.68; 705/14.69; 705/14.72; 709/217

(57) ABSTRACT

A method and system are disclosed which provide additional revenue stream to a client while providing training multimedia to a plurality of end users associated with the client. The method comprises comparing a client profile to a plurality of advertisements, selecting an advertisement from the plurality of advertisements based on the client profile, combining the selected advertisement with the training multimedia to create a combined multimedia, and delivering the combined multimedia to a selected one of the plurality of end users.

### CROSS REFERENCE TO PRIOR APPLICATIONS

This application claims priority and the benefit thereof from U.S. Provisional Application No. 61/166,561, filed on Apr. 3, 2009, and entitled DYNAMIC MODELING ENGINE MATCHING CLIENT CONTROLS WITH ADVERTISER NEEDS, the entirety of which is herein incorporated by reference.

### FIELD OF THE DISCLOSURE

The present disclosure relates to a novel information delivery apparatus, method, system and computer program. More particularly, the disclosure is directed to an apparatus, a method, a system and/or a computer program for providing users with customized advertising information.

### BACKGROUND OF THE DISCLOSURE

When cutting costs, one of the first things that many organizations do is cut training budgets. However, this strategy frequently proves to be short term and costly. In economies like that of the United States, where a large majority of the workforce includes knowledge or information workers, inadequate training can quickly place an organization at a disadvantage compared to its competitors with better trained workers. For example, during the period from 2007 to 2008, average training expenditures fell 11%, from about $1,202 per learner in 2007 to about $1,075 in 2008. In financial services, average expenditures fell from about $1,061 per learner in 2007 to about $920 in 2008.

The disclosure provides a novel solution that provides effective training while providing additional revenue streams. This disclosure provides advertisers access to an untapped and high value universe of users.

### SUMMARY OF THE DISCLOSURE

An apparatus, a method, a system and a computer program are provided for providing additional revenue streams through highly targeted advertising delivered in conjunction with effective training.

According to an aspect of the disclosure, advertising revenue may be used, as a source of funding for learning and development in organization operations. Client-side parameters are matched with multimedia provided by advertisers. The multimedia may be delivered to the client end user during training events. The disclosure provides timely reporting to both the client and advertiser.

The multimedia may be delivered to one or more client end users over a communication network. The multimedia may be delivered based on a predetermined client fee and payment arrangement, such as, for example, a monthly service charge, a payment per advertising impression or set of impressions, or the like. The client may be given access to a network of advertisers. The client also may be given access to one or more websites to establish controls and advertiser parameters. The predetermined client fee arrangement may include, among other things, training, routine server maintenance, software updates and upkeep. Further, the predetermined client payment arrangement may include payment for qualified advertising impressions or sets of impressions.

Alternatively (or additionally), an advertiser may be given access to a network of clients. The advertiser may also be given access to one, or more websites for real time modeling. The advertiser may be granted access to the network of clients and/or the one or more websites based on a predetermined advertiser fee arrangement. The predetermined advertiser fee arrangement may include a service charge. Further, the predetermined advertiser fee arrangement may include charges for qualified advertising impressions or sets of impressions. The predetermined advertiser fee arrangement may include, among other things, routine server maintenance and upkeep.

Clients are provided with an ability to control client-side conditions and data, including but not limited to: the demographic information of its end users; which audiences will receive advertising; which organizations are allowed to advertise to the client's end users; which courses will contain advertising; the placement and type of advertising allowed; ensuring instructional integrity of learning and development products; minimizing any negative impact on employee capacity; maintaining and reinforcing corporate branding standards; maintaining compliance with regulatory matters, and the like.

According to a further aspect of the disclosure, a computer readable medium is provided that has a computer program tangibly embodied thereon, which when executed causes a general computer to carry out the processes described herein. The computer readable medium may include a plurality of instructions, code sections, or code segments for carrying out the processes.

According to a still further aspect of the disclosure, a method is provided for providing an additional revenue stream to a client while providing training multimedia to a plurality of end users associated with the client. The method comprises: comparing a client profile to a plurality of advertisements; selecting an advertisement from the plurality of advertisements based on the client profile; combining the selected advertisement with the training multimedia to create a combined multimedia; and delivering the combined multimedia to a selected one of the plurality of end users. The client profile may comprise a plurality of parameters. The parameters may comprise: demographic information of the selected end user; an organization identification that identifies an advertiser that is permitted to advertise to the plurality of end users; a course identification that identifies the training multimedia which may contain advertising; a location identification that identifies a location where the selected advertisement may be placed in the training multimedia; or an advertisement type identification that identifies the type of advertising that may be included in the training multimedia. The delivering the combined multimedia may comprise delivering the selected advertisement over a network. The combined multimedia may be delivered to the end user based on a predetermined client fee or payment arrangement. The plurality of parameters may comprise client controls and advertiser parameters. The demographic information may be stored on a cookie. The demographic information may comprise: a birth year; an age; a gender; a level of education achieved; a job title; a zip code; or an area code. The plurality of parameters may comprise client controls and advertiser parameters, and/or a course level information, which includes a type of available advertisements, a course title, a course subject, or a course length.

The method may further comprise generating a report that indicates an amount to be paid to the client based on the selected advertisement that is delivered to the selected one of the plurality of end users. The report may comprise: an advertiser name that is associated with the selected advertisement; a client name of the client; an end user identification of the selected one of the plurality of end users; an advertisement type of the selected advertisement; an advertisement duration of the selected advertisement; or a time-stamp indicating when the selected advertisement was delivered to the selected one of the plurality of end users. The method may further comprise giving a client access to a website to create or edit the plurality of parameters; and/or sending the report to the client or an advertiser associated with the selected advertisement.

According to a still further aspect of the disclosure, a system is provided for providing an additional revenue stream to a client while providing training multimedia to a plurality of end users associated with the client. The system comprises: a profile comparator that compares a client profile to a plurality of advertisements; an advertisement selector that selects an advertisement from the plurality of advertisements based on the client profile; a mixer that combines the selected advertisement with the training multimedia to create a combined multimedia; and an transmitter that sends the combined multimedia to a selected one of the plurality of end users. The client profile may comprise a plurality of parameters, which include: demographic information of the selected end user; an organization identification that identifies an advertiser that is permitted to advertise to the plurality of end users; a course identification that identifies the training multimedia which may contain advertising; a location identification that identifies a location where the selected advertisement may be placed in the training multimedia; or an advertisement type identification that identifies the type of advertising that may be included in the training multimedia.

The system may further comprise a report generator that outputs a report which indicates an amount to be paid to the client based on the selected advertisement that is delivered to the selected one of the plurality of end users. The report may comprise: an advertiser name that is associated with the selected advertisement; a client name of the client; an end user identification of the selected one of the plurality of end users; an advertisement type of the selected advertisement; an advertisement duration of the selected advertisement; or a time-stamp indicating when the selected advertisement was delivered to the selected one of the plurality of end users.

The system may further comprise a transmitter that sends the report to the client or an advertiser associated with the selected advertisement.

According to a still further aspect of the disclosure, a computer readable medium is provided that includes a tangibly embodied computer program, which, when executed on a computer, causes the computer to execute a method comprising: comparing a client profile to a plurality of advertisements; selecting an advertisement from the plurality of advertisements based on the client profile; combining the selected advertisement with the training multimedia to create a combined multimedia; and delivering the combined multimedia to a selected one of the plurality of end users. The method may further comprise: generating a report that indicates an amount to be paid to the client based on the selected advertisement that is delivered to the selected one of the plurality of end users; and sending the report to the client or an advertiser associated with the selected advertisement.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1A shows a table of an example of U.S. online and total media spending for 2006 through 2011;

FIG. 1B shows an example of an advertisement enhanced learning and development (AELD) system, according to principles of the disclosure;

FIG. 2 shows an example of a client-side system, according to principles of the disclosure;

FIGS. 3A, 3B, 3C, 3D, 3E, 3F, 3G, 3H show various examples of client controls, according to principles of the disclosure;

FIG. 4 shows an example of a multi-client system, according to principles of the disclosure;

FIG. 5 shows an example of an advertiser-side system, according to the principles of the disclosure;

FIGS. 6A, 6B, 6C, show three examples of advertiser-side models that may be used for mixing and matching advertisers to clients and/or end users;

FIG. 7 shows an example of a three-dimensional model for dynamically matching advertiser needs to client controls, according to the principles of the disclosure;

FIG. 8 shows a flow diagram of a process for mixing and matching advertisers to clients and/or end users, according to principles of the disclosure;

FIG. 9 shows another example of a multi-client system, according to principles of the disclosure;

FIG. 10 shows another, alternative example of a client-side system, according to principles of the disclosure;

FIG. 11 shows an example of an end user identification number, according to principles of the disclosure; and

FIG. 12 shows an example of end user control parameters, according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting-embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components, and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device, configured to communicate over a communication link. The electronic device may include, for example, but is not limited to, a mobile telephone, a personal data assistant (PDA), a mobile computer, a stationary computer, a smart phone, a mobile station, user equipment, or the like.

A “server”, as used in this disclosure, means any combination of software and/or hardware, including at least one application and/or at least one computer to perform services for connected clients as part of a client-server-architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model, or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like, or any combination of the foregoing.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, or any combination of the foregoing. The RF communication link may include, for example, WiFi, WiMAX, IEEE 802.11, DECT, 0G, 1G, 2G, 3G or 4G cellular standards, Bluetooth, or the like, or any combination of the foregoing.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be, involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

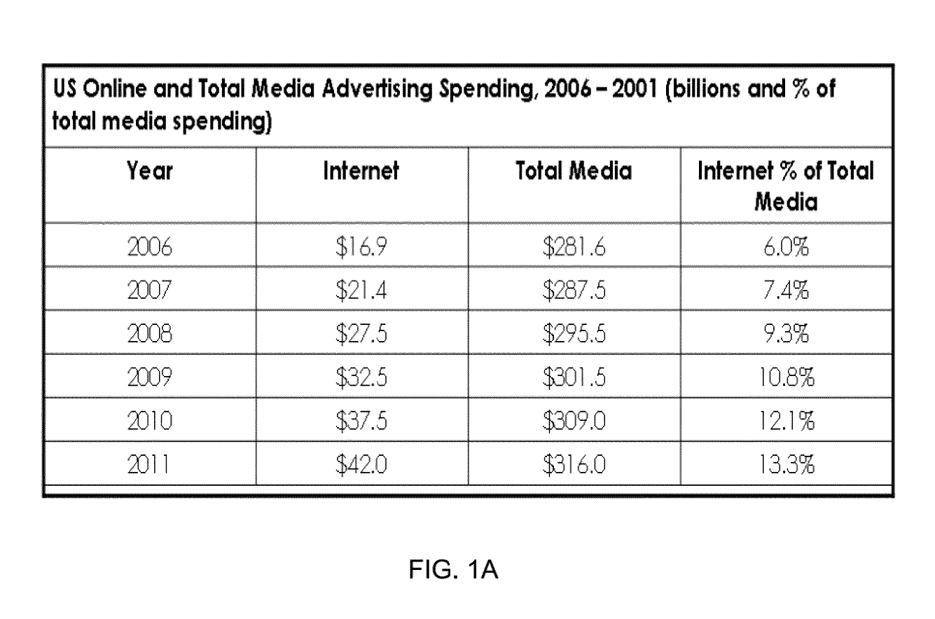

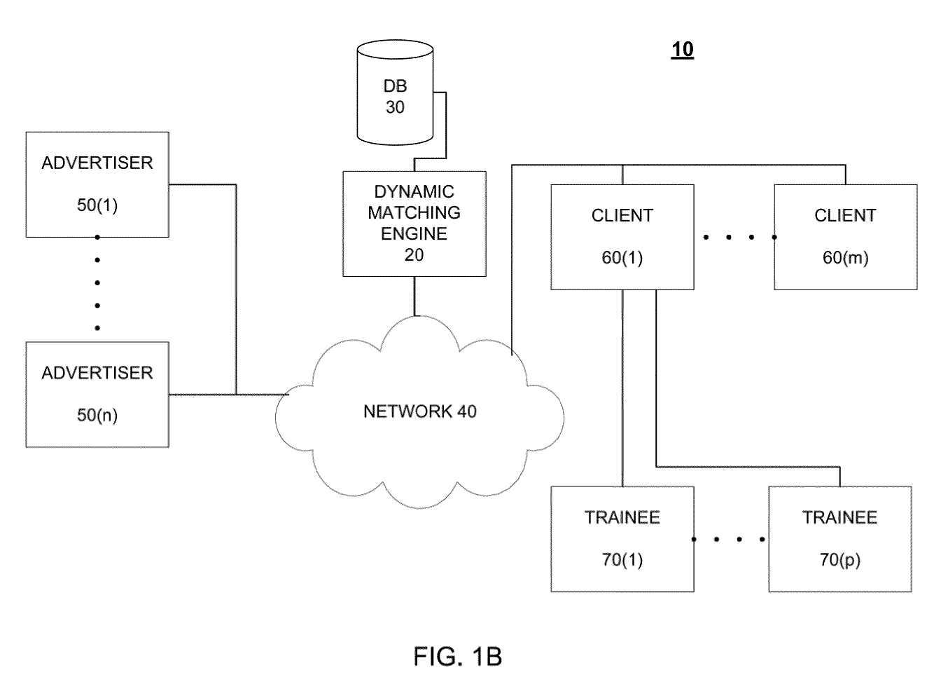

FIG. 1A shows a table of U.S. online and total media spending for a period from year 2006 through year 2011. U.S. online spending is expected to outpace total media spending over the period from 2006 to 2011. While U.S. online spending was about 6.0% of total media spending for the year 2006, with $16.9 billion being spent on Internet advertising compared to $281.6 billion spent on all media advertising, it is projected that U.S. online spending will increase to about 13.3% of the total media spending for the year 2011. Internet advertising may include, among other things, display advertisements (such as, for example, banners, pop-ups, or the like), paid search advertisements (including, for example, contextual links, text links, or the like), rich media (including video and/or audio), classified advertisements, sponsorships, referrals (including for example, lead generation) and e-mail (embedded advertisements). The total media advertising spending also includes television (broadcast and cable), radio, newspapers, magazines, outdoor, direct mail, yellow pages, and the like, but excludes mobile advertising.

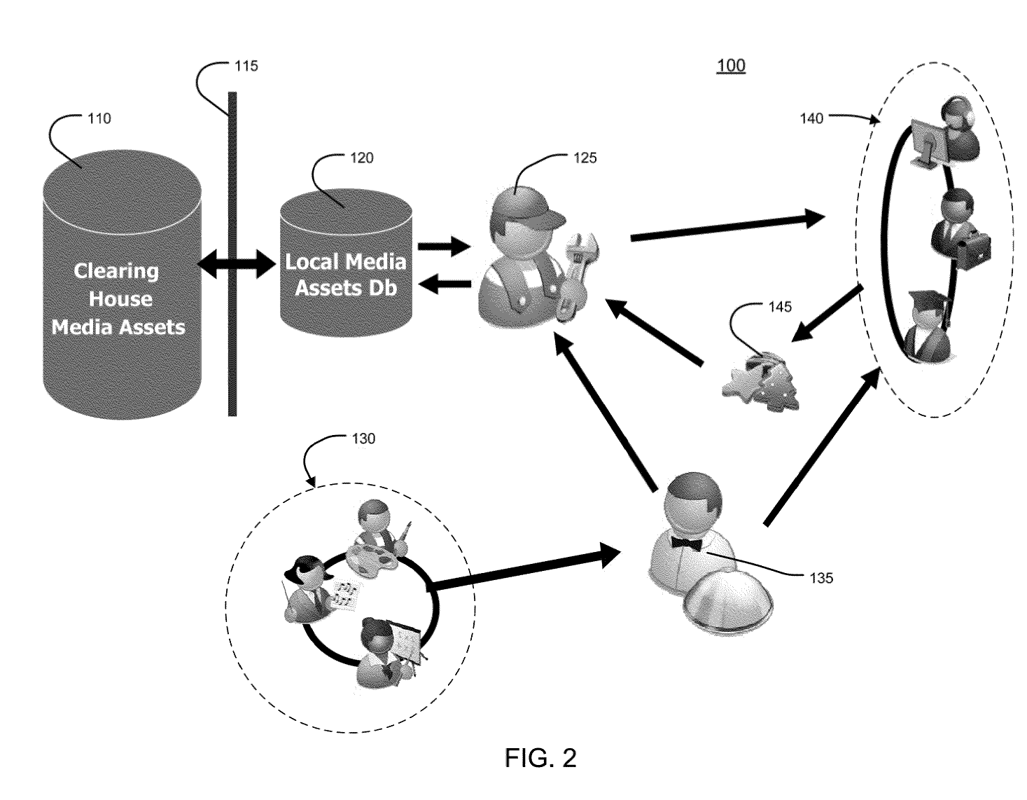

FIG. 1B shows an example of an advertisement enhanced learning and development (AELD) system 10, according to principles of the disclosure. The AELD system 10 includes a Dynamic Matching Engine (DME) 20, a database 30, a network 40, a plurality of advertisers 50 (e.g., advertiser 50(l) through client 50(n), where n is a positive, non-zero integer), and a plurality of clients 60 (e.g., client 60(l) through client 60(m), where m is a positive, non-zero integer). Each of the clients 60 in the AELD system 10 may include a plurality of trainees (or end users) 70 (e.g., trainee 70(l) through trainee 70(p), where p is a positive, non-zero integer). The trainees 70 each include a computer (not shown) that is configured to receive multimedia from one or more learning and development product (LDP) providers 130 (shown in FIG. 2). The multimedia includes learning and development multimedia materials such as, for example, seminars, continuing learning education (CLE) accredited presentations, virtual interactive classrooms, or the like, which are provided to the trainees 70 as video and/or audio presentations.

As seen in FIG. 1B, the DME 20, advertisers 50 and clients 60 may be communicatively coupled through the network 40. Alternatively (Or additionally), the trainees 70 and/or database 30 may also be coupled directly to the network 40. The AELD system 10 may provide advertising revenue from advertisers 50 to the clients 60, which may be used by the clients as a source of funding for learning and development operations within the clients 60.

The DME 20 includes a computer (not shown). The DME 20 is configured to match one or more profiles provided by the clients 60 with advertisements provided by the advertisers 50. When a match is determined between the one or more profiles provided by the clients 60 and the advertisements provided by the advertisers 50, the advertisements are combined with the multimedia and delivered as combined multimedia to the trainees 70 that are associated with the matching profiles. The DME 20 is further configured to provide timely reporting to either, or both, the clients 60 and advertisers 50.

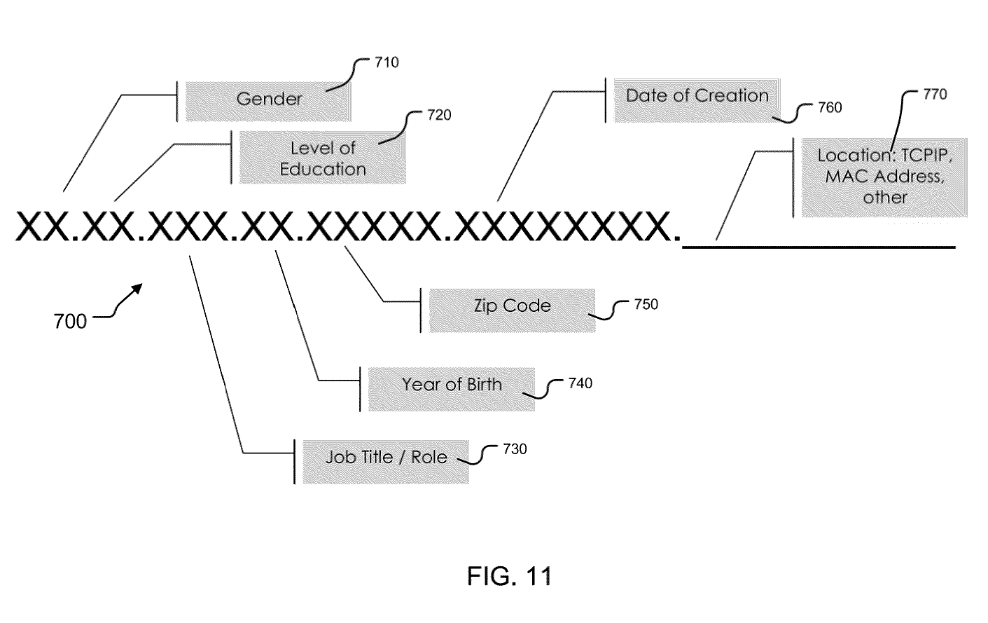

The DME 20 may track and create reports for the advertisers 50 and/or clients 60. The reports may include any one or more of, for example, an advertiser name, a client name, a trainee 70 identifier (e.g., a unique number, shown in FIG. 11), an advertisement type, an advertisement name, an advertisement duration, a time-stamp of when the advertisement was sent, and the like. The reports may assist in determining a value of each impression to an advertiser 50(n), determining a dollar-amount to be paid to the client 60(m) based on, for example, a number of advertisements delivered and tracked, accuracy of the advertisements delivered, and the like.

In the AELD system 10, editorial control rests with the clients 60. In this regard, the clients 60 may maintain control and management oversight. The clients 60 may ensure instructional integrity of products produced by learning and development product (LDP) providers 130 (shown in FIG. 2). The clients 60 may minimize negative impact on employee (or trainee) capacity while maintaining and reinforcing corporate branding standards. The clients 60, using the AELD system 10, may remain compliant with regulatory matters. The clients 60 determine whether advertising is to be permitted. If permitted, the clients 60 determine how much advertising is acceptable, where it is acceptable and when it is acceptable.

FIG. 2 shows an example of a client-side system 100 of the advertisement enhanced learning and development (AELD) system, according to principles of the disclosure. The client-side system 100 includes a firewall 115, a Local Media Assets (LMA) database 120, a Dynamic Matching Engine (DME) 125, one or more learning and development product (LDP) providers 130, a Learning Management System (LMS) 135, one or more trainees (or end users) 140 and one or more cookie modules 145, or similar trainee identification modules. The client-side system 100 may connect to a Clearing House Media Assets (CHMA) database 110 through the firewall 115. The DME 125, LDP providers 130, LMS 135, and trainees 140, may each include a computer.

A trainee 140 may provide non-intrusive trainee (or end-user) information that may interest advertisers. The trainee information may be provided as a one time occurrence, stored on a cookie 145, or the like, or provided periodically at predetermined times or when trainee, information has been modified. The trainee information may include, for example, the trainee's year of birth, gender, level of education achieved, job title, zip code, annual family income, hobbies, marital status, whether the individual has children, and the like. The trainee information may be collected and built into a profile file (or record) for the trainee, which may be stored in the LMA database 120 and/or the Clearing House Media Assets database 110.

The LMS 135 may provide learning and development product (LDP) information. The LDP information may include, for example, a type of advertising available, a course subject, a course title, a course length, and the like.

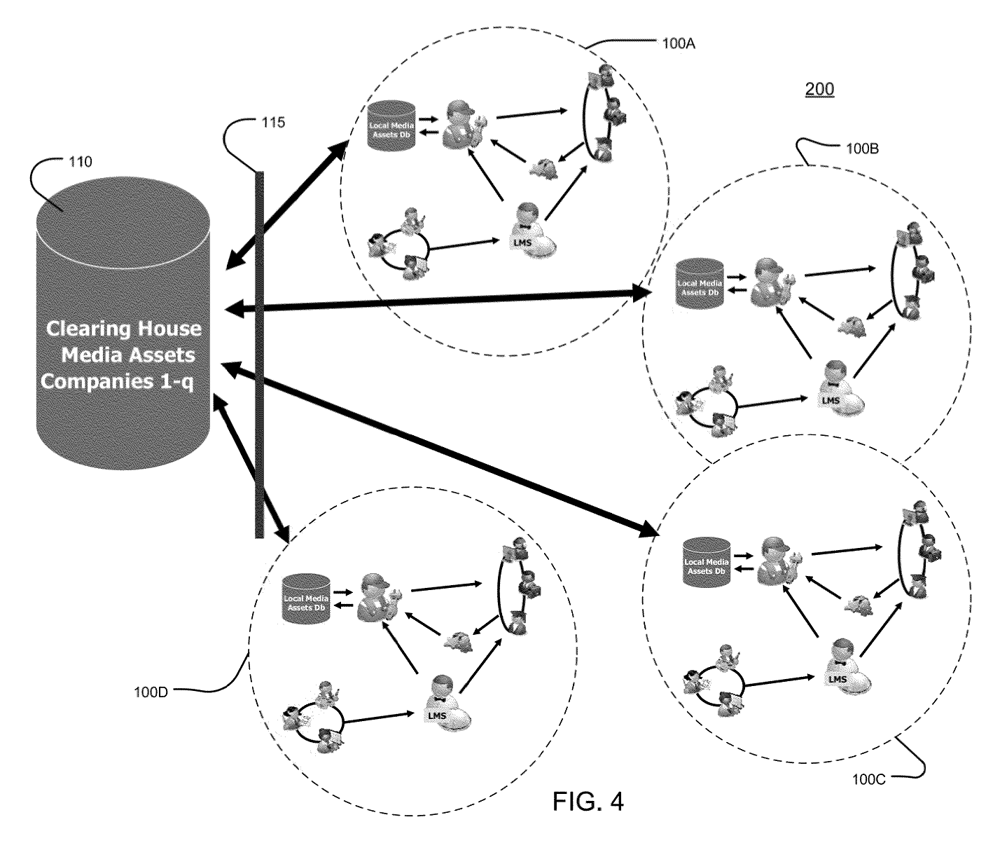

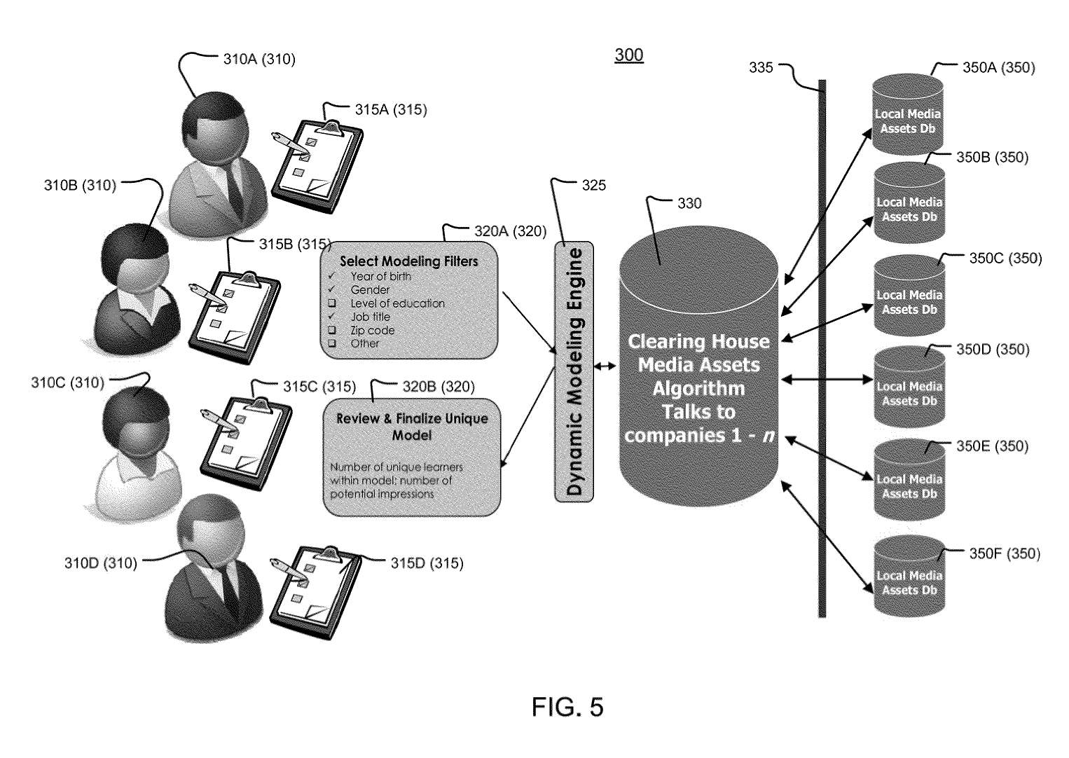

As seen in FIG. 2, multimedia may be received in the LMA database 120 from the CHMA database 110 through the firewall 115. The multi-media includes one or more advertisements from an advertiser(s), wherein the advertisements may include, for example, video content, audio content, still images, animations, click to print, coupons, and the like. The DME 125 selects certain of the multimedia, including advertisements, from the LMA database 120 using, for example, information/instructions received from the LMS 135 and/or cookie modules 145. The selected multimedia may then be combined with the learning and development media received from the LDP providers 130. The combined multimedia, including the advertisement and the learning and development media, may then be forwarded to the one or more particular trainees 140 or an audience (or group) of particular trainees 140. Additionally (or alternatively), the combined multimedia may be forwarded to the LMA database 120 and/or the CHMA database 110 for storage. The combined multimedia also may be sent to other clients 100B-100D (shown in FIG. 4) and/or advertisers 310 (shown in FIG. 5) through the firewall 115.

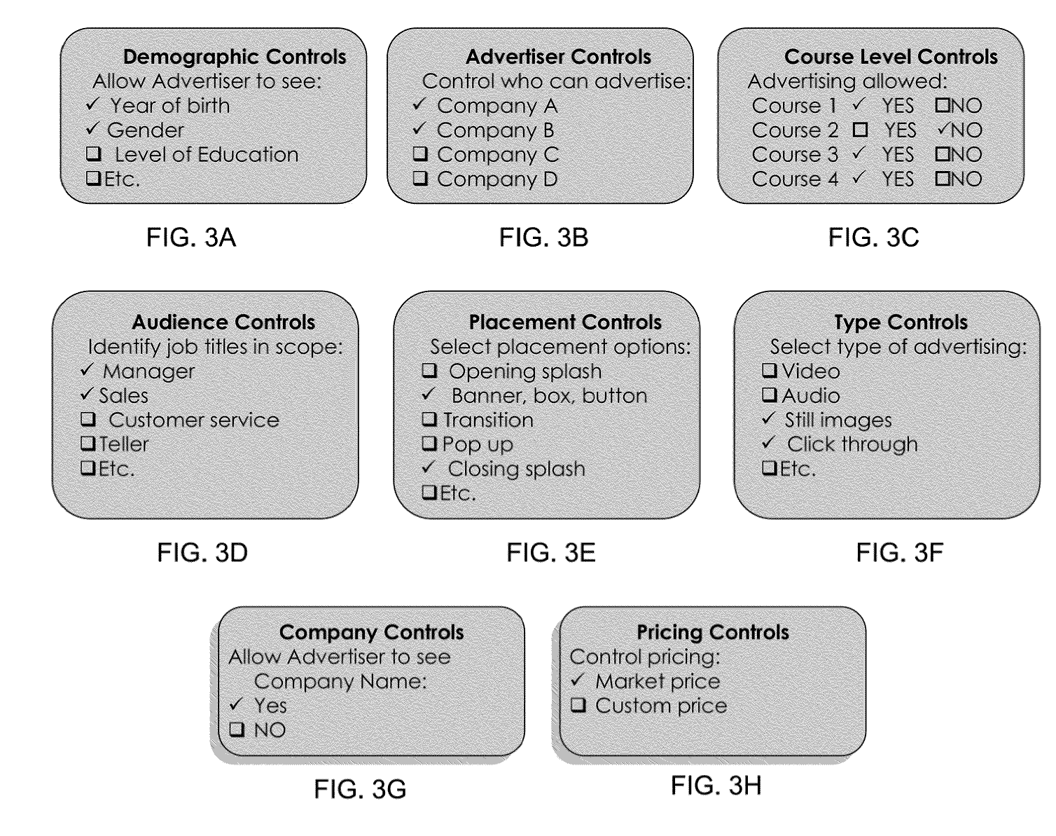

FIGS. 3A, 3B, 3C, 3D, 3E, 3F, 3G, 3H, show various examples of client controls or parameters that may be combined into, and stored as a client profile associated with a particular client 100, according to principles of the disclosure. In particular, FIG. 3A shows an example of demographic controls; FIG. 3B shows an example of advertiser controls; FIG. 3C shows an example of course level controls; FIG. 3D shows an example of audience controls; FIG. 3E shows an example of placement controls; FIG. 3F shows an example of type controls; FIG. 3G shows an example of company controls; and FIG. 3H shows an example of pricing controls. The various examples of client controls may be provided as, for example, displayable menus, each of which may be accessed through a dropdown menu, individually accessed, or accessed from a plurality of scrolling displays, or the like. The menus may be displayed on a graphic user interface (GUI) device that is capable of both displaying the menus and receiving data and/or instructions from a user. The various client controls are combined into a client profile and stored, for example, locally in the DME 125 and/or the CHMA database 110 for each of the clients 100.

As seen in FIG. 3A, a client can control what a particular advertiser may be permitted to see, including, for example, year of birth, gender, level of education, job title, zip code, annual family income, hobbies, marital status, whether the individual has children, and the like, of a particular end user, or group of end users. A selection may be made by selecting one or more particular demographic parameters, such as, for example, year of birth and gender. The selection may be displayed by a check mark, or the like.

In FIG. 3B, the client may control who can advertise by selecting one or more advertiser controls or parameters, including, for example, predetermined companies from a list of advertisers that may provide advertisements. Additionally, advertiser parameters may be added, removed or added to the list through the firewall 115 via the CHMA database 110 (shown in FIG. 2).

In FIG. 3C, the client may select one or more course level controls or parameters, such as, for example, courses for which advertising may be allowed. For example, the client may elect to allow certain advertisements to be added to Course 1, Course 3 and Course 4, but not to Course 2.

In FIG. 3D, the client may select one or more audience controls or parameters by, for example, identifying a job title, a job responsibility, a role, or the like. The job title may include one more titles, including, for example, Manager, Sales, Customer Service, Teller, and the like.

In FIG. 3E, the client may select one or more placement controls or parameters, such as, for example, opening splash, banner, box, button, transition, pop up, closing splash, or the like.

In FIG. 3F, the client may select one or more media type controls or parameters, such as, for example, video, audio, still image, click through, click to print, coupon, call to action, or the like.

In FIG. 3G, the client may select one or more company controls or parameters, such as, for example, a company name, and whether the company name may be visible or accessible to the advertiser.

In FIG. 3H, the client may select a pricing control or parameter, such as, for example, market price; custom price, or the like.

Additionally, each of the client controls in FIGS. 3A to 3F may be modifiable by the client. For example, the client may add, remove, or edit any parameter in the control menu, including, but not limited to, for example, demographic parameters, advertiser parameters, course parameters, audience parameters, placement parameters, type parameters, and the like. It is noted that FIGS. 3A through 3H are only examples of client controls and one of ordinary skill in the art will recognize that other variations or types of client controls may be included, without departing from the scope or spirit of the disclosure.

FIG. 4 shows an example of a multi-client system 200, according to principles of the disclosure. In the multi-client system 200, a plurality of clients 100A, 100B, 100C, 100D, similar to the client 100 (shown in FIG. 2), may be communicatively coupled to the CHMA database 110 through the firewall 115. The CHMA database 110 may include multimedia, including advertisements, from a plurality of advertisers, such as, for example, Companies 1 to q, where q is a non-zero positive integer.

FIG. 5 shows an example of an advertiser-side system 300, according to the principles of the disclosure. The advertiser-side system 300 includes a plurality of advertisers 310 (for example, advertisers 310A through 310D), a plurality of User Interface Devices (UIDs) 315 (for example, UIDs 315A through 315D), a Dynamic Matching Engine (DME) 325, a Clearing House Media Assets (CHMA) database 330, a firewall 335 and a plurality of Local Media Assets (LMA) databases 350 (for example, LMA databases 350A through 350E).

The UIDs 315 (315A-315D), as well as the DME 325, the CHMA database 330, the firewall 335 and the plurality of LMA databases 350 each include a computer. Each of the plurality of databases 350 may be associated with a unique client, similar to the client-side system 100 shown in FIG. 2.

Referring to FIG. 5, an advertiser 310A may select filters and priorities using the UID 315A. The available filters and priorities may include, for example, year of birth, gender, level of education achieved, job title, zip code, type of advertising available, course subject, course title, course length, and the like. The advertiser 310A may model various scenarios and select the most advantageous scenario. The advertiser 310A may review and finalize a unique model for the selected scenario.

The DME 325 matches the filter and priority data received from the advertisers 310 with the client controls received from the clients 100, using, for example, relational databases, or the like. The DME 325 may include, for example, artificial intelligence (AI) or expert systems, including, for example, neural networks, fuzzy logic, and the like. Based on the matches, the DME 325 may send appropriate multimedia, including advertisements, to be combined with learning and development multimedia and forwarded to targeted trainees 140 (shown in FIG. 2) as combined multimedia. The DME 325 may track and create reports for the advertisers 310 and/or client-side systems. The reports may include any one or more of, for example, an advertiser name, a client name, a trainee identifier (e.g., a unique number, shown in FIG. 11), an advertisement type, an advertisement name, an advertisement duration, a time-stamp of when the advertisement was sent, and the like. The reports may assist in determining a value of each impression to an advertiser 310, determining a dollar-amount to be paid to the client 100 based on, for example, a number of advertisements delivered and tracked, accuracy of the advertisements delivered, and the like.

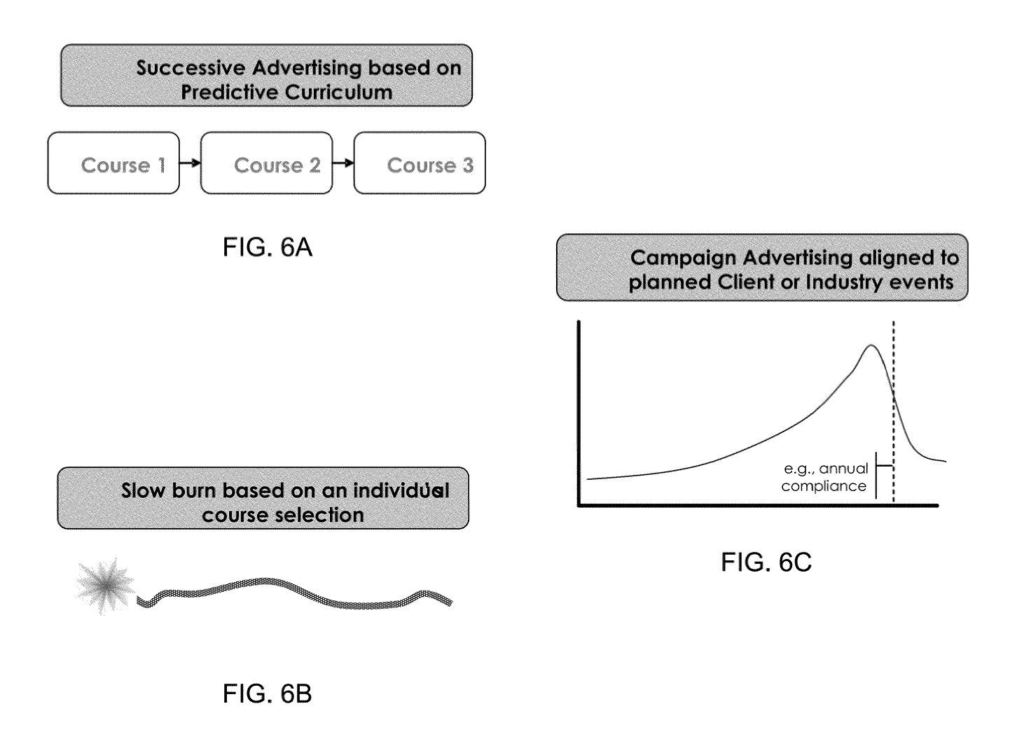

FIGS. 6A, 6B, 6C, show three examples of advertiser-side models that may be used for mixing and matching advertisers 310 (shown in FIG. 5) to clients 100A-100D (shown in FIG. 4) and/or trainees 140 (shown in FIG. 2).

FIG. 6A shows an example of successive advertising based on a predictive curriculum. In this regard, particular advertisers 310 (shown in FIG. 5) and/or particular advertisements may be mixed and matched with particular clients 100A-100D (shown in FIG. 4) and/or trainees 140 (shown in FIG. 2) based on a sequence of courses. For example, a particular advertisement may be targeted to a basic level course (for example, Course 1) and another related advertisement may be targeted to a subsequent level course (for example, Course 2 or Course 3). In this regard, the particular advertisement and related advertisement may be added to the multimedia content provided for the basic level course (Course 1) and subsequent level course(s) (Course 2 or Course 3).

FIG. 6B shows an example of a slow burn model based on an individual course selection. In this regard, particular advertisements may be mixed and matched to particular segments of a selected course. The advertisements may be added based on time stamps, content triggers, or the like, in the course multimedia content.

FIG. 6C shows an example of campaign advertising which may be aligned to planned client or industry events. In this regard, particular advertisements may be mixed and matched based on the event schedules of clients or industry events, so that the type of advertisement, advertisement content, number of advertisements, advertisement length, and the like, may be matched to event schedules. For example, the number of advertisements may increase as a time-line approaches a scheduled event, as seen in FIG. 6C.

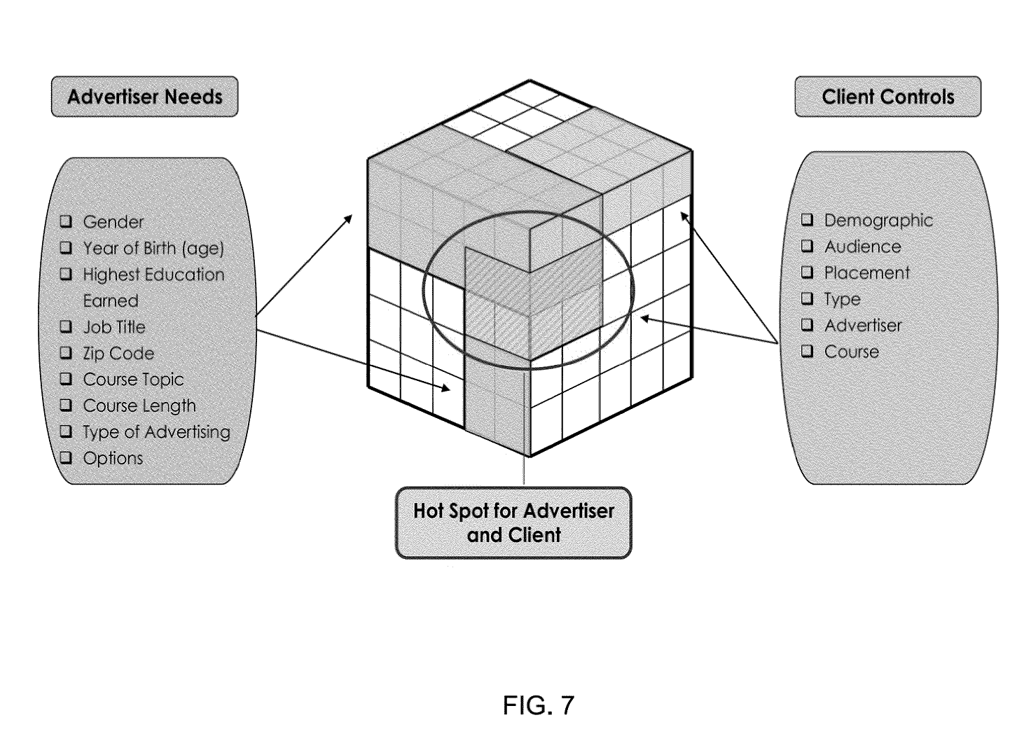

FIG. 7 shows an example of a three-dimensional model for dynamically matching advertiser needs to client profiles, according to the principles of the disclosure. As seen in FIG. 7, advertiser needs (such as, for example, gender, year of birth, age, highest education earned, job title, zip code, area code, course topic, course title, course length, type of advertising, options, and the like) may be matched to client controls (such as, for example, demographic, audience, placement, type, advertiser, course, and the like) in the respective client profiles. The relational matches may result in one or more intersection points for the advertisers 310 and/or clients 100.

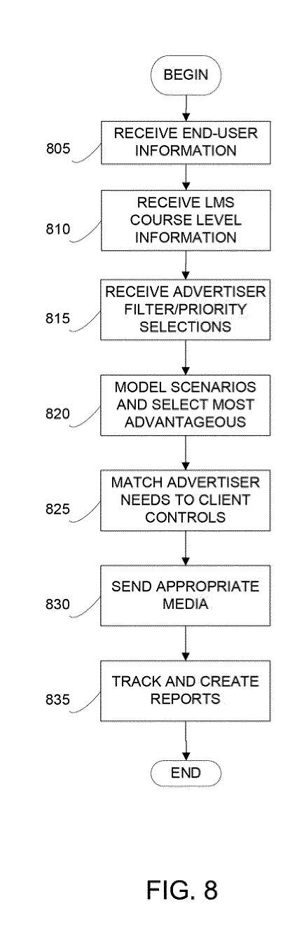

FIG. 8 shows a flow diagram of a process for mixing and matching advertisers 310 to clients 100 and/or trainees 140, according to principles of the disclosure.

Referring to FIGS. 2, 3A-3H and 8, non-intrusive information may be received from a trainee 140 (shown in FIG. 2) that interests advertisers 310 (shown in FIG. 3), such as, for example, a one time event that may be stored on a cookie (Step 805). The information provided may include, for example, year of birth, age; gender, level of education achieved, job title, zip code, area code, and the like. Course level information may be received from an LMS 135 (shown in FIG. 2) (Step 810). The course level information may include, for example, a type of advertising available, a course title, a course subject, a course length, and the like. Filter and/or priority information may be received from the advertisers 310 (Step 815). The filter/priority information may include, for example, year of birth, age, gender, level of education achieved, job title, zip code, type of advertising available, course title/subject, course length, and the like. The advertiser 310 may model various scenarios and select the most advantageous model (Step 820). Based on the trainee information, the course level information, and the advertiser selected filters/priorities, the advertiser's 310 needs may be matched to the client 100 (shown in FIGS. 2 and 4) controls (Step 825). Appropriate multimedia may be sent to the client(s) 100 and to the targeted trainees 140 based on the matches determined (Step 830). The multimedia that is sent to the client 100 and targeted trainees 140 may be tracked and compiled into reports, which may be sent to the advertiser 310 and/or client 100 (Step 835).

A computer readable medium (not shown) may be provided that includes a computer program, which when executed by a general purpose computer, may cause each of the steps 805 through 835 in the process shown in FIG. 8 to be carried out according to the principles of the disclosure. The computer readable medium may include an instruction (for example, code section or code segment) corresponding to each of the steps 805 through 835.

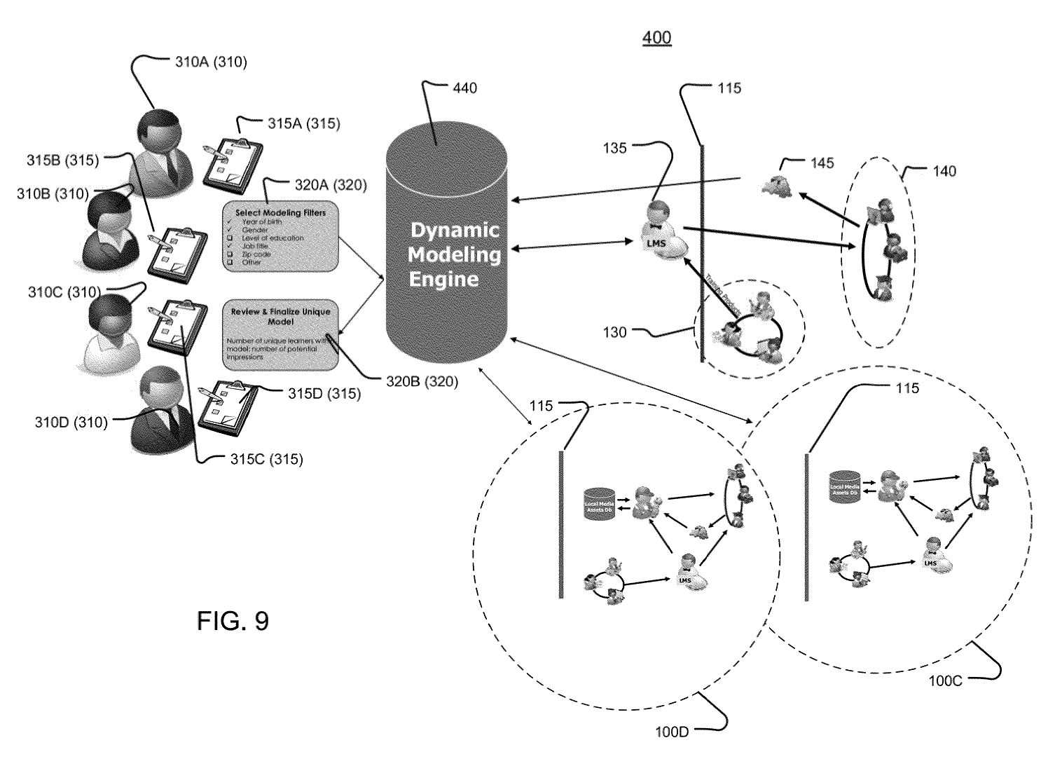

FIG. 9 shows another example of a multi-client system 400, according to principles of the disclosure. In addition to the foregoing discussion provided with regard to FIG. 4 and FIG. 5, the multi-client system 400 may include a Dynamic Matching Engine (DME) 440, which may include the CHMA database 330 (shown in FIG. 5), the LMA databases 350 (shown in FIG. 5), and the DME 325 (shown in FIG. 5). Further, the LMS 135 may be located outside a client firewall 115, and each of the clients 100C, 100D may include an individual firewall 115.

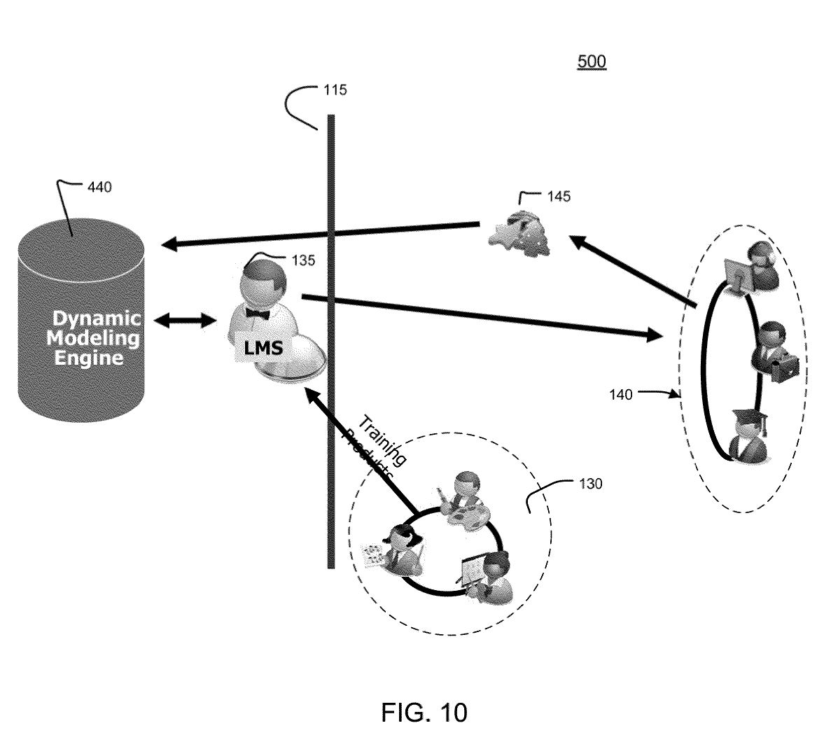

FIG. 10 shows another example of a client-side system 500, according to principles of the disclosure. Further to the foregoing discussion, the LMS 135 may be located outside a firewall 115 of the client 500.

FIG. 11 shows an example of a trainee identification number 700, according to principles of the disclosure. The number 700 may include, for example, a gender identifier portion 710, a level of education identifier portion 720, a job title identifier portion 730, a year of birth identifier portion 740, a zip code identifier portion 750, a date of creation identifier portion 760, a location identifier portion 770, and the like.

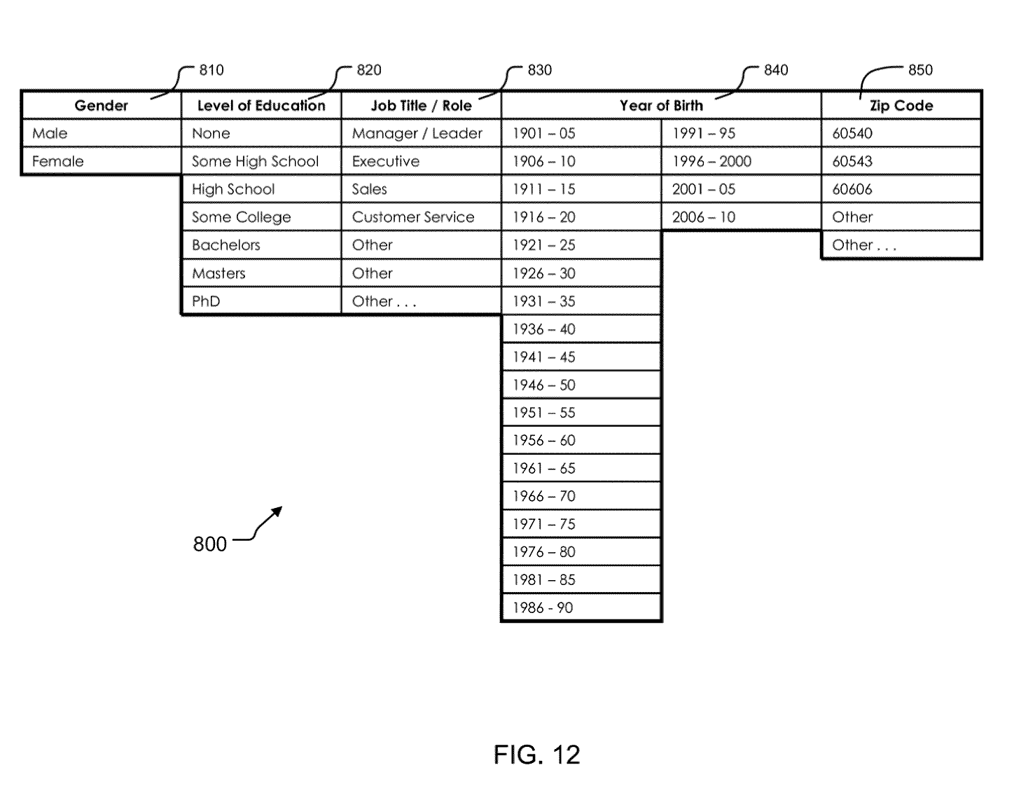

FIG. 12 shows an example of trainee control parameters 800, according to principles of the disclosure. In particular, FIG. 12 shows selectable control parameters for a particular trainee 140 (shown in FIG. 2), including, for example, a gender parameter 810 (for example, Male or Female), a level of education parameter 820 (for example, Some High School, High School, Some College, Bachelors, Masters, or PhD), a job title/role parameter 830 (for example, Manager/Leader, Executive, Sales, Customer Service, or Other), a year of birth parameter 840 (for example, 1901-05, 1906-10, 1911-15, . . . , 2001-05, 2006-10, or the like), a zip code parameter 850 (for example, 60540, 60543, 60606, or the like), and the like.

It is noted that any one or more of the databases 110, 120, 330, 350, the DMEs 125, 325, 440, the LMS 135, the LDP providers 130, the trainees 140, and the advertisers 310, may also include one or more servers (not shown). It is further noted that the multi-media may be conveyed over communication links, as is known by those having ordinary skill in the art.

A computer readable medium (not shown) may be provided that includes a computer program, which when executed by a general purpose computer, may cause each of the processes performed in the systems 100, 200, 400, 500 to be carried out according to the principles of the disclosure. The computer readable medium may include an instruction (for example, code section or code segment) corresponding to each step in the processes.

Although the disclosure has been provided with reference to several embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

In accordance with various embodiments of the present disclosure, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

Although the present specification describes components and functions implemented in the embodiments with reference to particular standards and protocols, the disclosure is not limited to such standards and protocols. Accordingly, replacement standards and protocols having the same functions are considered equivalent.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A method for providing an additional revenue stream to a client while providing training multimedia to a plurality of end users associated with the client, the method comprising:
comparing a client profile to a plurality of advertisements;
selecting an advertisement from the plurality of advertisements based on the client profile;
combining the selected advertisement with the training multimedia to create a combined multimedia; and
delivering the combined multimedia to a selected one of the plurality of end users.

2. The method of claim 1, wherein the client profile comprises a plurality of parameters.

3. The method of claim 2, wherein the parameters comprise:
demographic information of the selected end user;
an organization identification that identifies an advertiser that is permitted to advertise to the plurality of end users;
a course identification that identifies the training multimedia which may contain advertising;
a location identification that identifies a location where the selected advertisement may be placed in the training multimedia; or
an advertisement type identification that identifies the type of advertising that may be included in the training multimedia.

4. The method of claim 1, further comprising:
generating a report that indicates an amount to be paid to the client based on the selected advertisement that is delivered to the selected one of the plurality of end users.

5. The method of claim 4, wherein the report comprises:
an advertiser name that is associated with the selected advertisement;
a client name of the client;
an end user identification of the selected one of the plurality of end users;
an advertisement type of the selected advertisement;
an advertisement duration of the selected advertisement; or
a time-stamp indicating when the selected advertisement was delivered to the selected one of the plurality of end users.

6. The method of claim 4, further comprising:
sending the report to the client or an advertiser associated with the selected advertisement.

7. The method of claim 1, wherein delivering the combined multimedia comprises:
delivering the selected advertisement over a network.

8. The method of claim 1, wherein the combined multimedia is delivered to the end user based on a predetermined client fee or payment arrangement.

9. The method of claim 2, further comprising:
giving a client access to a website to create or edit, the plurality of parameters.

10. The method of claim 2, wherein the plurality of parameters comprise client controls and advertiser parameters.

11. The method of claim 3, wherein the demographic information is stored on a cookie.

12. The method of claim 3, wherein the demographic information comprises:
a birth year;
an age;
a gender;
a level of education achieved;
a job title;
a zip code; or
an area code.

13. The method of claim 2, wherein the plurality of parameters comprise a course level information, which includes a type of available advertisements, a course title, a course subject, or a course length.

14. A system for providing an additional revenue stream to a client while providing training multimedia to a plurality of end users associated with the client, the system comprising:
a profile comparator that compares a client profile to a plurality of advertisements;
an advertisement selector that selects an advertisement from the plurality of advertisements based on the client profile;
a mixer that combines the selected advertisement with the training multimedia to create a combined multimedia; and
an transmitter that sends the combined multimedia to a selected one of the plurality of end users.

15. The system of claim 14, wherein the client profile comprises a plurality of parameters, which include:
demographic information of the selected end user;
an organization identification that identifies an advertiser that is permitted to advertise to the plurality of end users;
a course identification that identifies the training multimedia which may contain advertising;
a location identification that identifies a location where the selected advertisement may be placed in the training multimedia; or
an advertisement type identification that identifies the type of advertising that may be included in the training multimedia.

16. The system of claim 14, further comprising:
a report generator that outputs a report which indicates an amount to be paid to the client based on the selected advertisement that is delivered to the selected one of the plurality of end users.

17. The system of claim 16, wherein the report comprises:
an advertiser name that is associated with the selected advertisement;
a client name of the client;
an end user identification of the selected one of the plurality of end users;
an advertisement type of the selected advertisement;
an advertisement duration of the selected advertisement; or
a time-stamp indicating when the selected advertisement was delivered to the selected one of the plurality of end users.

18. The system of claim 16, further comprising:
a transmitter that sends the report to the client or an advertiser associated with the selected advertisement.

19. A computer readable medium that includes a tangibly embodied computer program, which, when executed on a computer, causes the computer to execute a method comprising:
comparing a client profile to a plurality of advertisements;
selecting an advertisement from the plurality of advertisements based on the client profile;
combining the selected advertisement with the training multimedia to create a combined multimedia; and
delivering the combined multimedia to a selected one of the plurality of end users.

20. The medium of claim 19, wherein the method further comprises:
generating a report that indicates an amount to be paid to the client based on the selected advertisement that is delivered to the selected one of the plurality of end users; and
sending the report to the client or an advertiser associated with the selected advertisement.
